(19) United States
(12) Patent Application Publication
(10) Pub. No.: US 2024/0375864 A1
(43) Pub. Date: Nov. 14, 2024

(54) Rack arrangement

(71) Applicant: NEDCON B.V., Doetinchem (NL)

(72) Inventors: Pieter A.M. Hommelberg, Ede (NL); Jarno Hummelink, Zieuwent (NL)

(73) Assignee: NEDCON B.V., Doetinchem (NL)

(21) Appl. No.: 18/655,384

(22) Filed: May 6, 2024

(30) Foreign Application Priority Data
May 8, 2023 (DE) 10 2023 111 918.4

(51) Int. Cl. B65G 1/02; B65G 1/04

(52) U.S. Cl. CPC B65G 1/026; B65G 1/0492

(57) ABSTRACT

A rack arrangement for item-storage, has an aisle, in which an automatically operated storage-and-retrieval vehicle can travel, a first rack element on one side of the aisle, a second rack element on the opposite side of the aisle, a rail arrangement on the rack elements, the storage-and-retrieval vehicle being able to travel on the rail arrangement, and item carriers, which are arranged in the rack elements and have their longitudinal extent in a direction transverse to the aisle. Each item carrier is a single-piece profile element having a bearing surface for the stored item. Each item carrier has material deformations in certain portions along its longitudinal extent. Located between longer, main longitudinal portions, on which the item carrier has the same, uniform cross-sectional shape, are short longitudinal portions, on which the item carrier has a different cross-sectional shape caused by the material deformation.

### CROSS-REFERENCE TO RELATED APPLICATION

This application claims the benefit of German Patent Application DE 10 2023 111 918.4, filed on May 8, 2023, the content of which is incorporated by reference in its entirety.

### BACKGROUND

Rack arrangement for item-storage purposes are often very extensive. Such rack arrangements have, on both sides of an aisle, rack elements with a multiplicity of compartments arranged one beside the other and one above the other. For item-storage purposes, the compartments are often formed from item carriers which are used in pairs, which extend in a direction transverse to the aisle and of which the upper sides, together, form a bearing surface for the items which can be stored in the respective compartment. The item carriers themselves are profiles which can be produced in a cost-effective manner. It is from the aisle that the individual compartments or storage locations are loaded with the articles and, conversely, the items are also removed, the latter usually resting on pallets. Such arrangements are known, for example, from EP 1 559 346 B1, EP 2 468 138 B1 and DE 10 2020 122 840 A1.

In the case of the rack arrangement according to DE 10 2009 030 030 B4, the items are loaded and removed by a storage-and-retrieval vehicle which can travel automatically in the aisle-a so-called “shuttle”. This vehicle is guided on rails, for which purpose a rail arrangement made up of a first running rail, which is fastened on the first rack element, and a second running rail, which is fastened on the second rack element, is provided. In addition to travelling longitudinally along the longitudinal direction of the rack, the vehicle is capable of moving an integrated extension arm laterally to the left or right into the adjacent compartments, in order to set down pallets on the item carriers or to receive them therefrom.

The item carriers, which are arranged in a direction transverse to the aisle, are usually profiles, and mostly downwardly open U-shaped profiles, which can be produced from stamped sheet-metal parts, and in particular sheet-metal panels, by way of a small number of therefore relatively inexpensive bending processes. Furthermore, item storage in compartments which are open on one side or both sides also requires various additional measures. Rear boundary stops are therefore often necessary, these preventing items from being set down on the item carriers too far into the same, as seen in the longitudinal direction. In addition, lateral stops are often necessary in order to prevent lateral offsetting of the stored items. For example, gradual lateral offsetting of the pallet or of the item can be caused by vibrations which are introduced into the rack element as a result of the movement and the work carried out by the shuttle. Such influences can be caused, in particular, when the running rails for the shuttle are fastened at the ends of the elongate item carriers, or in the vicinity thereof, and running-rail deformations therefore also have an effect on the item carriers.

The aforementioned measures, and also other measures, require corresponding additional components, which likewise have to be mounted, and then fixed, within the rack element. Both of these operations result in additional outlay, which relativizes or qualifies the advantage associated, in principle, with inexpensive profiles.

### SUMMARY

The present application discloses a rack arrangement that is particularly easy to install. The rack arrangement for item-storage purposes includes an aisle, in which an automatically operated storage-and-retrieval vehicle can travel. A first rack element is arranged on one side of the aisle. A second rack element is arranged on an opposite, other side of the aisle. A rail arrangement is connected to the rack elements. The storage-and-retrieval vehicle is able to travel on the rail arrangement. Item carriers are arranged in the rack elements and have their longitudinal extent in a direction transverse to the aisle. Each item carrier is a single-piece profile element, of which the upper side forms a bearing surface for an item which can be stored on the item carrier. In the rack arrangement, the item carrier has material deformations in certain portions along its longitudinal extent. In particular located between longer, main longitudinal portions, on which the item carrier has the same, uniform cross-sectional shape, are short longitudinal portions, on which the item carrier has a different cross-sectional shape. The different cross-sectional shape here is based on a specific material deformation during production of the item carrier.

These measures are achieved by a particularly easy-to-install solution in which additional measures which are necessary or expedient within the context of largely automated item storage are achieved without any corresponding additional components, and therefore without the need for the corresponding additional components also to be mounted, and then fixed, within the rack element, both of which operations would result in additional outlay, and corresponding costs, during production of the rack elements.

Instead, in addition to the longer, main longitudinal portions, of which the function is in particular to support the item respectively resting thereon, the respective item carrier has longitudinal portions which are shorter in comparison and on which the item carrier has the different cross-sectional shape. Specific additional functions, which are important for reliable and problem-free item storage, are realized on these shorter longitudinal portions.

Such additional functions can constitute for example lateral boundaries or lateral stops for the item which can be stored on the bearing surface of the item carrier. Or the additional function consists in providing a boundary stop in the longitudinal direction for the item which can be stored on the bearing surface. Such a longitudinal stop ensures that the item or the bundle of items cannot be stored too far into the respective compartment, that is to say too far in the rearward direction.

The dependent claims specify preferred configurations of the rack arrangement.

The item carrier is preferably a single-piece profile element which is produced by bending processes and of which the upper side forms the bearing surface for the item. The item carrier is designed in the form of an upwardly open profile element of C-shaped profile cross section, wherein the two free ends of the profile cross section are directed towards one another and therefore, together, form the bearing surface. It is advantageous if the two ends extend horizontally in the same horizontal plane, so that the upper sides of the two ends, together, form the bearing surface for the item.

It is preferably the case for the rack arrangement that in each case two item carriers are arranged parallel to one another at a distance apart and, together, form a bearing means for the item which can be stored thereon, wherein the material deformations on the second item carrier are arranged in a mirror-inverted manner in comparison with the material deformations on the first item carrier.

It can be advantageous if, on the short longitudinal portions, the material deformations extend into a horizontal plane higher than the plane of the bearing surface.

The material deformations can each be lugs projecting from the item carrier, preferably lugs projecting as a result of a bending process.

Each item carrier can be designed in the form of an upwardly open profile of C-shaped profile cross section, wherein the two ends of the profile cross section are directed towards one another and, together, form the bearing surface for the item.

It is also proposed that the lugs should be cut out by way of transverse slits in the material of the item carrier, wherein the transverse slits are located in one of the two ends of the profile cross section and the bearing surface has an interruption between the transverse slits.

For the purpose of providing lateral stops for the item which can be stored on the bearing surface, it is proposed that the lugs on a plurality of the short longitudinal portions should extend laterally beyond the bearing surface. In this case, all the lugs extending laterally beyond the bearing surface are located on the same side, as seen in relation to the longitudinal center line of the item carrier.

For the purpose of providing a boundary stop in the longitudinal direction for the item, it is proposed that a lug on one of the short longitudinal portions should extend upwards beyond the bearing surface.

The rail arrangement should comprise a first running rail, which is fastened on the first rack element, and a second running rail, which is fastened on the second rack element, wherein those ends of the item carriers which are directed towards the aisle are supported directly on the respective running rail. The running rail can be a profile of S-shaped profile cross section.

The running rail can have formed on it a running-surface portion, on which wheels of the storage-and-retrieval vehicle can travel, and a carrying portion, which supports the ends of the item carriers.

In order to prevent the items from tilting during longitudinal displacement, it may be provided that guide sections are assigned to the material deformations, whereby the guide sections have an inclination to the longitudinal extension of the items carrier when viewed from above on the support surface.

The guide sections serve to ensure that any eccentrically moved goods slide along the guide sections in order to be centered and aligned parallel to the longitudinal extension of the items carrier. This prevents the items from tilting between the material deformations.

Opposite guide sections of neighboring product carriers can form a funnel shape.

Two guide sections can be assigned to each material deformation in order to enable centering and guidance along the longitudinal extension of the items carrier in both directions of movement.

The guide sections can be part of the lugs. The guide sections can therefore be an integral part of the lugs and in particular be formed in one piece with the lugs. In this way, a cost-effective integration of the lugs can be achieved.

The guide sections can be attachments attached to the tabs, in particular attachments that are plugged onto the lugs. In this way, the attachments can be replaceable as wearing parts and/or their dimensions can be adapted to the items to be stored. The guide sections can also be retrofitted to existing systems.

### BRIEF DESCRIPTION OF THE DRAWINGS

Further details will be described hereinbelow with reference to the associated drawing, in which:

FIG. 1 shows a side view of a single bearing plane of a rack arrangement, having compartments arranged on both sides of an aisle, having items stored in the compartments, and having a storage-and-retrieval vehicle arranged between the compartments;

FIG. 2 shows an end view of two adjacent compartments, as seen from the aisle, wherein each of the two compartments comprises two item carriers, and wherein, to simplify the illustration, the stored items have not been illustrated; and

FIG. 3 shows a combined illustration-made up of a plan view, a side view and a cross section—of the item carrier arranged to the left of the aisle in FIG. 1;

FIG. 4 shows a further embodiment of an item carrier for a rack arrangement;

FIG. 5 shows a further embodiment of an item carrier for a rack arrangement.

### DETAILED DESCRIPTION

The rack arrangement described here serves for the fully automatic storage and retrieval of items W, and preferably of items on standardized pallets or in standardized containers. The rack arrangement is used for example in an extensive (pallet) warehouse. The items W are stored therein in standard compartments, large numbers of which are arranged one beside the other and on levels one above the other.

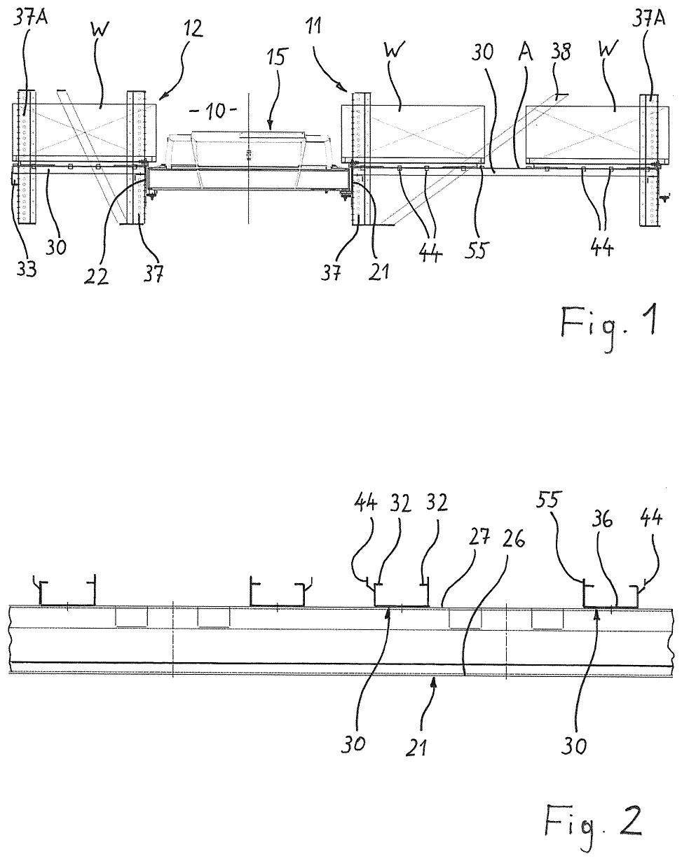

In the case of the exemplary embodiment in FIG. 1, items W are located in a first rack element 11 on the one side—in this case the right-hand side—of an aisle 10 and other items W are located in a second rack element 12 on the opposite side—in this case the left-hand side—of the aisle 10. It is the case here, once again in the form of an exemplary embodiment, that the first rack element 11 is provided for item storage with a two-sided and therefore double storage depth, whereas the second rack element 12 is provided for item storage with just a single storage depth.

Items are loaded and removed by a storage-and-retrieval vehicle 15 which can travel automatically and in particular in a program-controlled manner in the aisle-a so-called “shuttle”. This vehicle is guided on rails along the aisle 10, for which purpose a rail arrangement made up of a right-hand running rail 21, which is fastened on the first rack element 11, and a left-hand running rail 22, which is fastened on the second rack element 12, is present in each plane of the rack arrangement. In addition to travelling longitudinally along the longitudinal direction of the rack, the storage-and-retrieval vehicle 15 is designed to move an extension arm laterally to the left or right into the compartments located there, in order to set down items on rack-mounted item carriers 30 or, conversely, or to receive them from the item carriers 30.

The item carriers 30 extend in a direction transverse to the longitudinal extent of the aisle 10 and are present in pairs for each compartment, i.e. the loaded pallet or item W stored in the compartment rests, at the same time, on an upper side of the first item carrier and on an upper side of the second item carrier. Each item carrier 30 is a single-piece profile element, of which the upper side forms a bearing plane for the vertically supported item W.

The item carriers 30 extend parallel to one another and have their front end, which is directed towards the aisle 10, supported directly on the respective, rack-mounted running rail 21, 22 of the rail arrangement. In addition, they can be fixed on the running rail.

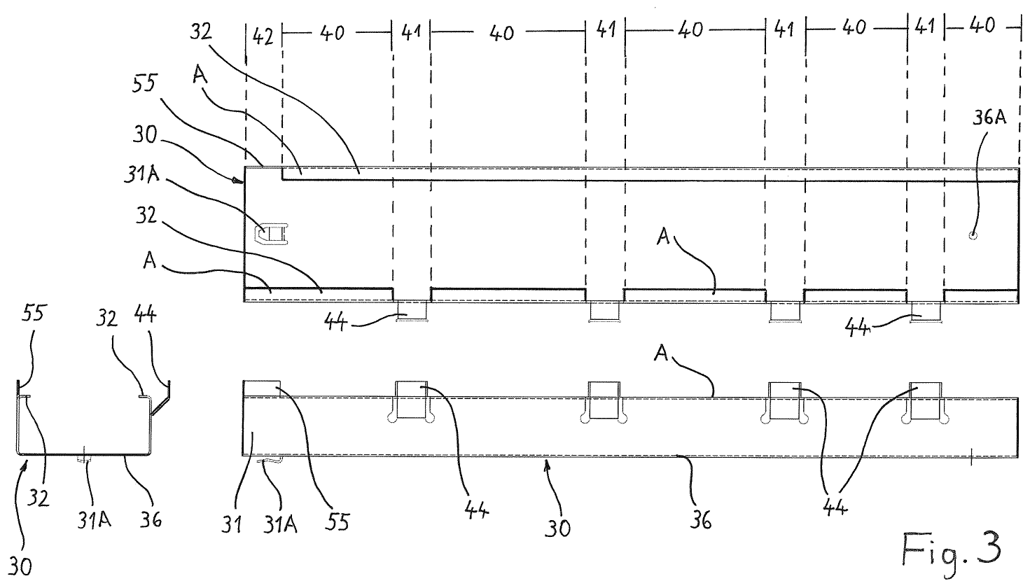

In an analogous manner, the other, rear ends of the item carriers 30 can be fastened in an adjacent, parallel aisle. As an alternative—see FIG. 3—the item carriers 30 can be provided at their rear ends 31 with a lug 31A which has been formed on in a single piece. The lug 31A is formed so as to jut out freely in the rearward direction. The item carrier 30 can be fixed by means of the lug 31A, without any screw connection being required, in an aperture of a rear crossmember 33, which extends parallel to the aisle 10. It is advantageous from the point of view of installation that this mounting operation, and at the same time fixing operation, can take place from the aisle 10 without any tools being used.

The running rails 21, 22 and/or rear crossmembers 33 are, for their part, fastened on vertical supports 37, 37A, which are part of the static basic structure of the rack arrangement. Further constituent parts of this basic structure can be carriers which run in a direction transverse to the aisles 10 and connect together supports 37, 37A arranged one behind the other, and/or they can be diagonal struts 38 between the front supports 37 and rear supports 37A.

The running rail 21, 22, which allows the shuttle 15 to roll along the aisle 10, is a profile of preferably S-shaped profile cross section. On the profile, a running-surface portion 26, on which the wheels of the shuttle can travel, is formed on a lower level and a carrying portion 27 is formed on a higher level. The front ends of the item carriers 30, these ends being directed towards the aisle 10, are supported on the carrying portion 27. There is no need, and no provision, for these ends to be supported for example on additional crossmembers or carriers.

The front ends of the item carriers 30 are fixed on the carrying portion 27 at least in the longitudinal direction of the item carriers 30. They are preferably also fixed in the direction transverse to the item carriers. Both of these operations are achieved for example by a screw or a bolt, passing vertically at the same time through a hole 36A in the base 36 of the item carrier 30 and through a hole in the carrying portion 27 of the running rail 21, 22.

The item carrier 30 is a single-piece profile element which is produced by bending processes and of which the upper side forms the bearing means for the item W. In the case of the exemplary embodiment, the item carrier 30 is designed in the form of a profile element of C-shaped profile cross section, wherein the C-shaped profile cross section is arranged horizontally, therefore being open in the upward direction. The two free ends 32 of the profile cross section are directed towards one another, and their flat upper sides form the bearing surface A for the stored items W. The profile cross section of the profile element is therefore made up of the horizontal base 36, two vertically or approximately vertically running side walls and the two free ends 32, which between them bound the opening of the profile cross section. The ends 32 are directed towards one another and extend horizontally in the same horizontal plane, so that the upper sides of the two ends 32, together, form the two-part bearing surface A for the items W.

Over its length, the item carrier 30 is not of constant profile cross section. Rather, it is provided with material deformations 44, 55 in certain portions along its longitudinal extent, these material deformations resulting, on these portions, in a different cross-sectional shape. Specifically, the configuration is such that located between longer, main longitudinal portions 40 of the item carrier 30, on which the latter has the same, uniform cross-sectional shape, are longitudinal portions 41, 42, which are short in comparison and on which the item carrier 30, as a result of the material deformation 44, 55, has a cross-sectional shape which is different to the cross-sectional shape on the main longitudinal portions 40. The main longitudinal portions 40 preferably alternate with the comparatively short longitudinal portions 41, 42.

Since the item carriers 30 are arranged in pairs in each compartment, the material deformations 44, 55 on the second item carrier are arranged in a mirror-inverted manner in comparison with the material deformations 44, 55 on the first item carrier.

The function of the main longitudinal portions 40 of the item carriers 30, these main longitudinal portions being longer in comparison, is, in particular, to provide the bearing surface A for the stored item W. The total length of the main longitudinal portions is therefore preferably at least 4 times the total length of the short longitudinal portions 41, 42.

In the case of the exemplary embodiment in FIG. 3, the number of main longitudinal portions 40, on which the item carrier 30 has in each case the same, uniform cross-sectional shape, is five. This number should be at least three.

On account of the material deformations 44, 55, the item carrier 30 does not have the profile cross section of rectangular and symmetrical basic shape on the longitudinal portions 41, 42, which are shorter in comparison, as it does on the main longitudinal portions 40; rather, it has a profile cross section which is asymmetric in relation to the profile centre. The different cross-sectional shapes on the short longitudinal portions 41, 42 are linked with specific additional functions which play a role in an item-storage context and which the item carrier 30 therefore likewise performs.

The material deformations 44, 45 are each lugs which project outwards from the otherwise rectangular basic shape of the item carrier 30.

The lug 44, 55, which can be configured so as to be rectilinear or angled one or more times, is preferably produced by a bending process. The bending process is constituted by the cold forming of a flat sheet-metal blank to give the C-shaped profile of the item carrier 30. The bending process is preceded by a stamping process. The sheet-metal blank is provided with slits, which run from its edge and extend in a direction transverse to the longitudinal extent of the sheet-metal blank or subsequent item carrier. The sheet-metal material arranged between the transverse slits is first of all cut out in this way. The lugs 44, 55 are then formed from the sheet-metal regions thus cut out.

Since the transverse slits are located in one of the two free ends 32 of the finished profile cross section, and therefore at the location where the bearing surface extends, this results in the bearing surface A having an interruption between the transverse slits. However, the load-bearing capability of the item carrier 30 is not significantly weakened thereby because this capability is based, in particular, on the sufficiently long main longitudinal portions 40.

The material deformations in the form of the lugs 44, 55 all project from the rectangular basic shape of the item carrier 30 such that they extend into a horizontal plane which is arranged at a higher level than the bearing plane A.

For the purpose of providing lateral stops for the stored item, the lugs 44, which are present on the short longitudinal portions 41, additionally extend laterally beyond the actual bearing surface A. These lugs 44 are all located on the same side, as seen in relation to the longitudinal centre line of the item carrier 30. The additional function achieved by the lugs 44 is that of preventing excessive lateral offsetting of the stored item W. For example, gradual lateral offsetting of the item can be caused by vibrations which are introduced into the rack element 11, 12 as a result of the movement and the work carried out by the shuttle 15. Such influences can be caused, in particular, since the item carriers 30 are fastened directly on the running rail 21 or 22 for the shuttle and are therefore particularly susceptible to vibrations.

Since two item carriers 30 are present for each compartment, the lugs 44 are arranged only on the mutually remote longitudinal edges of the two item carriers 30, and are not located on the mutually facing longitudinal edges.

A differently configured lug 55, which is present on the longitudinal portion 42, does likewise extend upwards beyond the bearing surface A, but not additionally to the side. The additional function achieved by the lug 55 is that of forming a rear boundary stop. This prevents an item W from being set down too far in the longitudinal direction of the item carriers 30.

The left-hand part of FIG. 1 and also FIG. 3 illustrate the item carrier 30 intended for use from one side, that is to say for use from one end or from one aisle. In the case of this embodiment, the already described lug 31A is formed on the base 36 of the item carrier 30, in order for the item carrier 30 to be fixed at the rear. The lug 55, which forms the rear boundary stop, is likewise located at the rear end of the item carrier 30.

The right-hand part of FIG. 1 illustrates a different embodiment, in the case of which the item carrier is of double length and is configured for use from both sides, it therefore being possible for items W to be stored and retrieved from two mutually remote ends and aisles. In this case, the at least one lug 55 is located approximately halfway along the double-length item carrier 30.

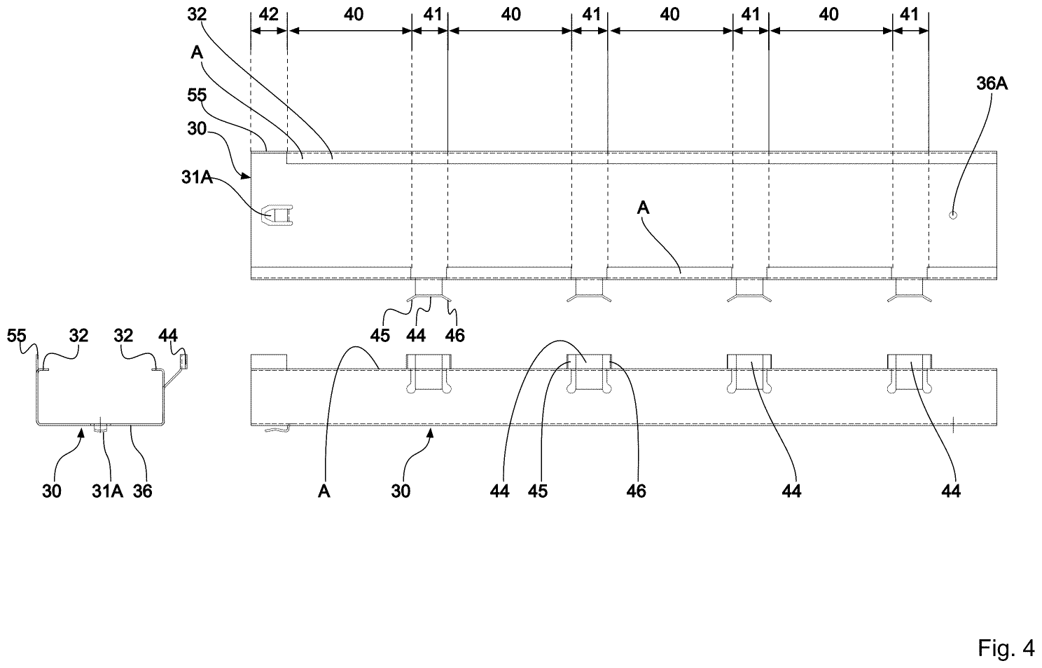

FIG. 4 shows a further embodiment of an item carrier 30 for a rack arrangement. To avoid repetition, only the differences to the item carrier 30 shown in FIG. 3 are discussed below, with the same reference signs being assigned to the same features.

According to FIG. 4, the item carrier 30 has guide sections 45, 46, the guide sections 45, 46 having an inclination to the longitudinal extension of the item carrier 30 when viewed from above on the support surface A.

The guide sections 45, 46 serve to ensure that any eccentrically moved items slide along the guide sections 45, 46 in order to be centred in this way and aligned parallel to the longitudinal extent of the item carrier 30. This prevents the items from tilting between the material deformations.

Opposite guide sections 45, 46 of neighbouring items carriers form a funnel shape.

Two guide sections 45, 46 are assigned to each material deformation 44 or lug 44.

The guide sections 45, 46 are part of the lugs 44. The guide sections 45, 46 are therefore an integral part of the lugs 44 and are formed in one piece with the lugs 44.

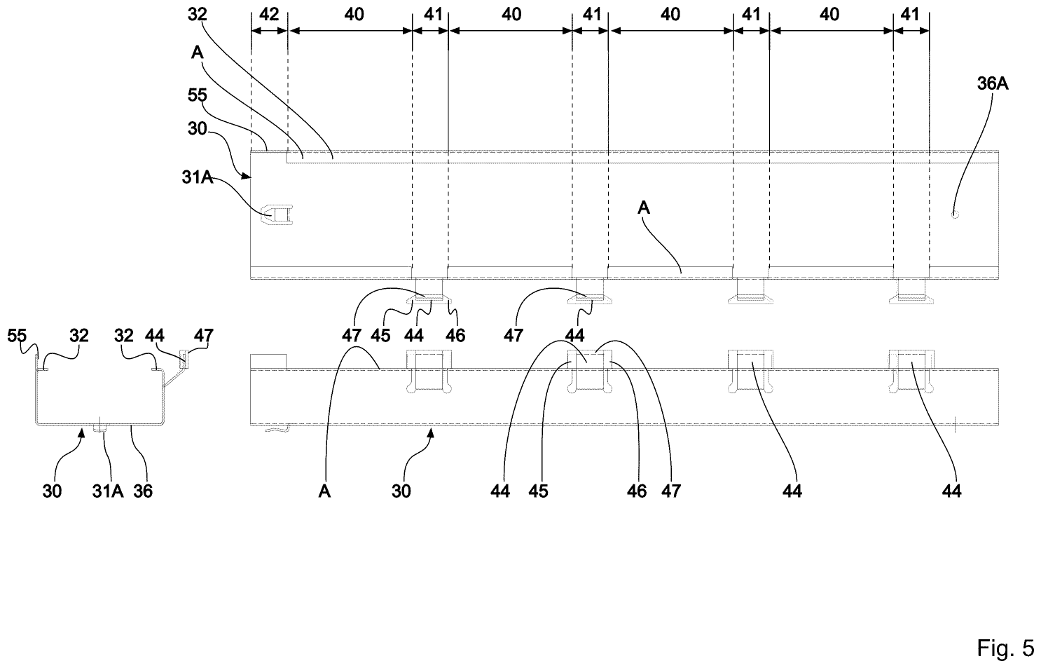

FIG. 5 shows a further embodiment of an item carrier 30 for a rack arrangement. To avoid repetition, only the differences to the item carrier 30 shown in FIG. 4 are discussed below, with the same reference signs being assigned to the same features.

According to FIG. 5, the item carrier 30 has guide sections 45, 46, which are attachments 47 attached to the lugs 44, namely attachments 47 which are plugged onto the lugs 44. Each attachment 47 forms two guide sections, namely a guide section 45 and a guide section 46.

### REFERENCE SIGNS

10 aisle
11 rack element
12 rack element
15 storage-and-retrieval vehicle (shuttle)
21 running rail
22 running rail
26 running-surface portion of the running rail
27 carrying portion of the running rail
30 item carrier
31 end of the item carrier
31A lug
32 end
33 crossmember
36 base
36A hole
37 front vertical support
37A rear vertical support
38 diagonal strut
40 main longitudinal portion
41 short longitudinal portion
42 short longitudinal portion
44 lug, material deformation
45 guide section
46 guide section
47 attachment
55 lug, material deformation
A bearing surface
W item

What is claimed is:

1. A rack arrangement for item-storage, comprising:
an aisle (10), in which an automatically operated storage-and-retrieval vehicle (15) can travel;
rack elements (11, 12), including
a first rack element (11) on one side of the aisle, and
a second rack element (12) on an opposite, other side of the aisle;
a rail arrangement on the rack elements (11, 12), the automatically operated storage-and-retrieval vehicle (15) being able to travel on the rail arrangement;
item carriers (30), which are arranged in the rack elements (11, 12) and have a longitudinal extent in a direction transverse to the aisle (10),
wherein each item carrier (30) is a single-piece profile element, of which an upper side forms a bearing surface (A) for an item (W) to be stored on the item carriers (30), and
wherein each item carrier (30) has material deformations (44, 55) in certain portions along its longitudinal extent,
wherein each item carrier (30) includes
main longitudinal portions (40) with a uniform cross-sectional shape, and, arranged therebetween,
short longitudinal portions (41, 42), having a different cross-sectional shape caused by the material deformations (44, 55),
the short longitudinal portions (41, 42) being shorter than the main longitudinal portions (40).

2. The rack arrangement according to claim 1,
wherein in each case two of the item carriers (30) are arranged parallel to one another at a distance apart and, together, form the bearing surface for the item (W) which can be stored thereon, and
wherein the material deformations (44, 55) on a second of the two of the item carriers are arranged in a mirror-inverted manner in comparison with the material deformations (44, 55) on a first of the two of the item carriers.

3. The rack arrangement according to claim 1,
wherein a total length of the main longitudinal portions (40) is at least four times a total length of the short longitudinal portions (41, 42).

4. The rack arrangement according to claim 1,
wherein a number of the main longitudinal portions (40) is at least three.

5. The rack arrangement according to claim 1,
wherein, on the short longitudinal portions (41, 42), the material deformations (44, 55) extend into a horizontal plane higher than a plane of the bearing surface (A).

6. The rack arrangement according to claim 1,
wherein the material deformations are lugs (44, 55) projecting from each item carrier.

7. The rack arrangement according to claim 1,
wherein each item carrier (30) is designed in form of an upwardly open profile having a C-shaped profile cross section,
wherein two ends (32) of the C-shaped profile cross section are directed towards one another and, together, form the bearing surface (A) for the item (W).

8. The rack arrangement according to claim 7,
wherein the material deformations are lugs (44, 55) projecting from each item carrier,
wherein the lugs (44, 55) are cut out by transverse slits in each item carrier (30),
wherein the transverse slits are located in one of the two ends (32) of the C-shaped profile cross section and the bearing surface (A) has an interruption between the transverse slits.

9. The rack arrangement according to claim 6,
wherein, for providing lateral stops for the item (W) which can be stored on the bearing surface (A), the lugs (44) on a plurality of the short longitudinal portions (41) extend laterally beyond the bearing surface.

10. The rack arrangement according to claim 9,
wherein all the lugs (44) extending laterally beyond the bearing surface (A) are located on one side relative to a longitudinal center line of each item carrier (30).

11. The rack arrangement according to claim 6,
wherein, for providing a boundary stop in a longitudinal direction for the item (W), a lug (55) on one of the short longitudinal portions (42) extends upwards beyond the bearing surface (A).

12. The rack arrangement according to claim 1,
wherein the rail arrangement comprises
a first running rail (21), which is fastened on the first rack element (11), and
a second running rail (22), which is fastened on the second rack element (12), and
wherein those ends of the item carriers (30) which are directed towards the aisle (10) are respectively supported directly on the first running rail (21) or the second running rail (22).

13. The rack arrangement according to claim 12,
wherein the first running rail (21) is a profile of S-shaped profile cross section.

14. The rack arrangement according to claim 12,
wherein the first running rail (21) has formed on it
a running-surface portion (26), on which wheels of the automatically operated storage-and-retrieval vehicle (15) can travel, and
a carrying portion (27), which supports the ends of the item carriers (30).

15. The rack arrangement according to claim 12,
wherein respective ends of the item carriers (30) are fixed on the first running rail (21) or the second running rail (22) at least in a longitudinal direction.

16. The rack arrangement according to claim 1,
wherein guide sections (45, 46) are assigned to the material deformations (44), the guide sections (45, 46) having an inclination to a longitudinal extension of the item carriers (30) when viewed in a plan view of the bearing surface (A).

17. The rack arrangement according to claim 16,
wherein opposite guide sections (45, 46) of adjacent item carriers (30) form a funnel shape.

18. The rack arrangement according to claim 16,
wherein the material deformations are lugs (44, 55) projecting from each item carrier, and
wherein the guide sections (45, 46) are part of the lugs (44) or in that the guide sections (45, 46) are attachments (47) fastened to the lugs (44), in particular attachments (47) fitted onto the lugs (44).
